(19) United States
(12) Patent Application Publication
(10) Pub. No.: US 2008/0101814 A1
(43) Pub. Date: May 1, 2008

(54) FIXER AND IMAGE FORMING APPARATUS INCLUDING SAME

(76) Inventor: Takahiro YOSHIKAWA, Sagamihara-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/928,454

(22) Filed: Oct. 30, 2007

(30) Foreign Application Priority Data
Nov. 1, 2006 (JP) 2006-298183

(51) Int. Cl. G03G 15/20

(52) U.S. Cl. 399/70; 399/331

(57) ABSTRACT

A fixer includes a fixing member configured to fix a toner image on a recording medium by application of heat, a coil part configured to extend in a width direction to face the fixing member, a core part configured to face the coil part and generate heat by electromagnetic induction to heat the fixing member when an electrical current passes through the coil part, and a shield configured to shield the core part partially to change a heating area thereof in the width direction. An amount of heat generated in an end portion of the core part in the width direction is changed when a predetermined number of sheets pass though the fixer during continuous feeding of sheets that are equal in size to a maximum heating area of the fixing member.

### CROSS-REFERENCE TO RELATED APPLICATIONS

This patent specification claims priority from Japanese Patent Application No. JP2006-298183, filed on Nov. 1, 2006 in the Japan Patent Office, the entire contents of which are hereby incorporated by reference herein.

### BACKGROUND OF THE INVENTION

1. Field of the Invention

The present invention generally relates to a fixer for an image forming apparatus using electromagnetic induction heating and an electronographic image forming apparatus, such as a copier, a printer, a facsimile machine, or a multi-function machine including functions of the above, including the fixer.

2. Discussion of the Background Art

In general, electrophotographic image forming apparatuses include an image forming unit for forming a toner image and a fixer for fixing the toner image on a sheet of recording media. In an image forming apparatus configured to perform printing at high speed, power supplied to a fixer is limited to hold total power consumption used by the image forming apparatus below an allowable amount.

A fixer includes a fixing member, a heating source, and a pressure member. The fixing member and the pressing member sandwich a sheet on which a toner image is transferred therebetween to fix the toner image on the sheet with heat and pressure. Therefore, limiting power to the fixer often causes a decrease in temperature of the fixing member when sheets are continuously printed because the sheets pass through the fixer draw heat therefrom.

To prevent a shortage of power for fixing, increasing intervals of sheet feeding, that is, reducing the number of copies per minute, has been suggested. Further, making up the shortage with an electric storage device has been suggested as well.

Although a related-art fixer including a fixing belt and a heating roller receives standby power during a standby state, heat is lost through a support member provided at an end of the fixing belt and temperature is lower in an end portion than in a center portion of the fixing belt. Therefore, when sheets are sent to the fixer and the fixing belt becomes a rotation state from a rest state (a standby state), the amount of heat generated in an end portion of the heating roller is set to a higher amount than the amount of heat generated in a center portion thereof. However, the center portion of the fixing belt loses heat through contact with the sheets, etc., while sheets pass through the fixer, and thus temperature becomes higher in the end portion than in the center portion (end portion temperature rising). Even when a maximum heating region of the fixing roller is used, temperature is higher in the end portion than in the center portion during a phase when temperature is stabilized. It should be noted that, generally, the maximum heating area of a fixer is set to a longer side of A4 sized-sheets or letter sized-sheets, which are most commonly used.

In one related-art example of an electromagnetic induction heating fixer, a fixing member is heated with an induction heating member including a coil and cores provided at positions facing the coil directly or indirectly. In this example, blocking a part of the core from the coil with a shield has been suggested as a method of preventing the end portion temperature from rising when a small-sized sheet passes through the fixer.

### SUMMARY OF THE INVENTION

In view of the foregoing, various embodiments of the present invention disclosed herein describe a fixer for an image forming apparatus that can enhance power efficiency for fixing.

In one embodiment, a fixer includes a fixing member configured to fix a toner image on a recording medium by application of heat, a coil part configured to extend in a width direction to face the fixing member, a core part configured to face the coil part and generate heat by electromagnetic induction heating to heat the fixing member when an electrical current passes through the coil part, and a shield configured to shield the core part partially to change a heating area thereof in the width direction. An amount of heat generated in an end portion of the core part in the width direction is changed when a predetermined number of sheets pass through the fixer during continuous feeding of sheets that are equal in size to a maximum heating area of the fixing member.

In another embodiment, an image forming apparatus includes an image carrier configured to carry a toner image thereon, a transferee configured to transfer the toner image from the image carrier onto a recording medium, and the fixer described above.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings, wherein:

FIG. 1 is an illustration of a laser printer as an image forming apparatus according to an example embodiment;

FIG. 2 illustrates a fixer according to an example embodiment;

FIGS. 3A and 3B illustrate a fixing roller;

FIG. 4 is a graph illustrating temperature distribution on a fixing belt in a width direction;

FIG. 5 shows one configuration of a control block of an auxiliary capacitor;

FIG. 6 is a graph illustrating differences in the amount of heat generated on a heating roller in a width direction;

FIG. 7 is a graph illustrating changes in temperature with time in different portions of the heating roller;

FIG. 8 is a graph illustrating distribution of heat generation when an auxiliary power storage unit is used;

FIG. 9 illustrates a method to raise temperature faster in end portions of the heating roller at the start of sheet feeding;

FIG. 10 illustrates a temperature detection position on the heating roller;

FIG. 11 is a flowchart illustrating heat generation control based on temperature detection at the end portion;

FIG. 12 is a graph illustrating changes in temperature depending on size of charge after sheet feeding is started; and

FIG. 13 illustrates differences in temperature change on the heating roller depending on fixing method.

### DETAILED DESCRIPTION OF PREFERRED EMBODIMENTS

In describing preferred embodiments illustrated in the drawings, specific terminology is employed for the sake of clarity. However, the disclosure of this patent specification is not intended to be limited to the specific terminology so selected, and it is to be understood that each specific element includes all technical equivalents that operate in a similar manner.

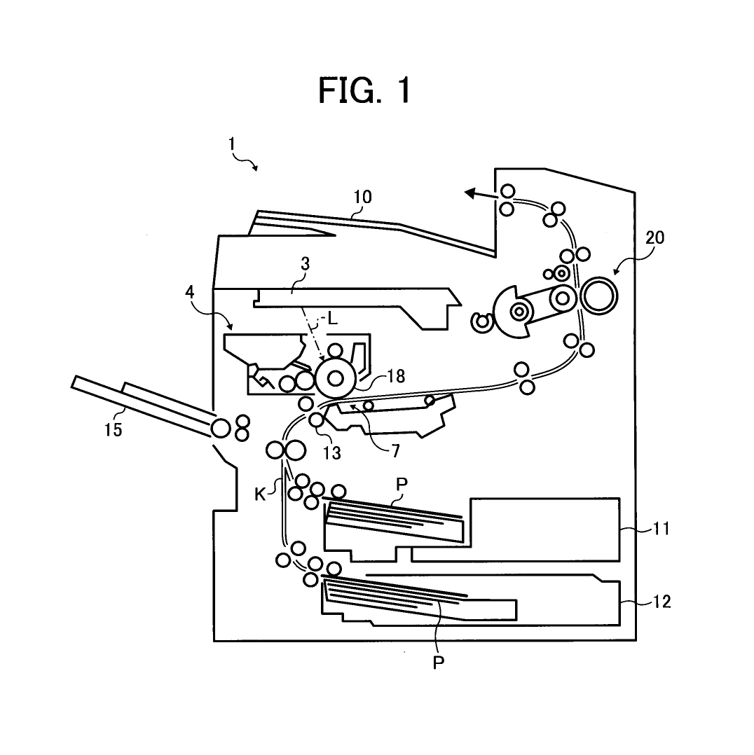

Referring now to the drawings, wherein like reference numerals designate identical or corresponding parts throughout the several views, particularly to FIG. 1, an image forming apparatus 1 according to an exemplary embodiment of the present invention is described. In the present embodiment, the image forming apparatus 1 is a laser printer.

Referring to FIG. 1, the image forming apparatus 1 includes an exposure part 3, a process cartridge 4, a transferer 7, an discharge tray 10, sheet feeders 11 and 12, a pair of registration rollers 13, a manual sheet feeder 15, a photoreceptor 18, and a fixer 20. The image forming apparatus 1 further includes a controller to control various functions thereof.

Operations of respective parts of the image forming apparatus 1 in image forming processes are described below.

While the photoreceptor 18 included in the process cartridge 4 rotates counterclockwise in FIG. 1, a toner image is formed on the photoreceptor 18 through a charging process, an exposure process, and a developing process. In the charging process, a charger, not shown, charges a surface of the photoreceptor 18 uniformly. In the exposure process, the exposure part 3 emits an exposure light L, which may be a laser light, to the photoreceptor 18, and thus an electrostatic latent image corresponding to image information is formed on the photoreceptor 18. The process cartridge 4 functions as an image forming unit and is attachable to and detachable from the image forming apparatus 1. In the developing process, the electrostatic latent image is developed with toner in the process cartridge 4.

The sheet feeders 11 and 12 store sheets of different sizes, or sheets of the same size placed in different directions. Along with the above-described image formation, one of the sheet feeders 11 and 12 is selected automatically or manually. In one example, the upper sheet feeder 11 is selected. A sheet P is fed from the sheet feeder 11 from the top though a transport path K to the pair of registration rollers 13.

The registration rollers 13 forward the sheet P in a timely manner to the transferer 7, where the toner image is transferred from the photoreceptor 18 onto the sheet P. The sheet is further sent to the fixer 20, where the toner image is fixed on the sheet P.

After the toner image is fixed, the sheet P is discharged onto the discharge tray 10 as an output image, and thus a series of image forming processes complete. The image forming apparatus 1 includes a function to count the number of sheets transported therethrough.

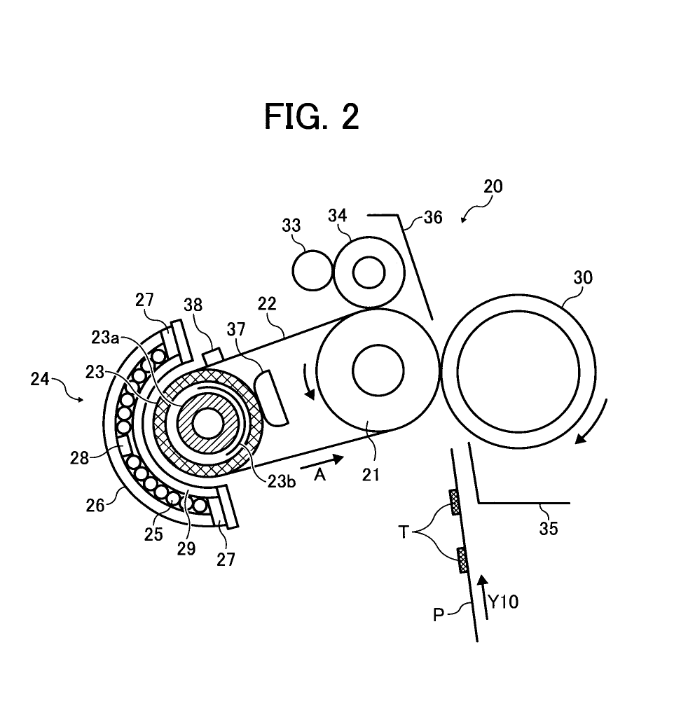

FIG. 2 illustrates the fixer 20. As shown in FIG. 2, the fixer 20 includes a fixing roller 21, a fixing belt 22 as a fixing member, a heating roller 23 as a heating member, an induction heating unit 24, a pressure roller 30, a cleaning roller 33, an oil application roller 34, a guide plate 35, a separation plate 36, a thermostat 37, and a temperature detector 38 such as a thermistor. The induction heating unit 24 includes a coil part 25, a coil guide 29, and core parts including a core 26, side cores 27, and a center core 28.

An elastic layer including silicone rubber, etc., is formed on a surface of the fixing roller 21. A driving mechanism, not shown, drives the fixing roller 21 to rotate counterclockwise in FIG. 2.

In an example, the heating roller 22 is a cylinder including a nonmagnetic metal such as SUS304 and rotates counterclockwise in FIG. 2. Inside the heating roller 23, an inner core 23a including a ferromagnetic material such as ferrite, etc., and shields 23b including a material of a lower permeability such as copper, etc. are provided. The inner core 23a is another core part and faces the coil part 25 via the fixing belt 22. The shields 23b are configured to shield both end portions of the inner core 23a in a width direction thereof. The inner core 23a and the shields 23b are configured to rotate integrally, independent of the heating roller 23.

The fixing belt 22 is stretched around the fixing roller 21 and the heating roller 23. The fixing belt 22 is a multilayer endless belt including a base layer, a heating layer, and a release layer (surface layer). The base layer may include polyimide resin, etc. The heating layer may include silver, nickel, iron, etc. The release layer may include a fluorine compound, etc., and provides a release property to a toner image T.

In an example, the coil part 25 is a litz wire including many thin wires, provided to cover a part of the fixing belt 22 in a width direction thereof that is vertical to the paper surface of FIG. 2. The coil guide 29 includes a resin of high heat resistance and holds the coil part 25, the core 26, the side cores 27, and the center core 28.

The core 26, the side cores 27, and the center core 28 include a material of a higher permeability such as ferrite, etc. The core 26 is provided to face the coil part 25, which extends in the width direction. The side cores 27 are provided at each end of the coil part 25. The center core 28 is provided in a center portion of the coil part 25.

The core part of the fixer 20 are cores that are provided on both sides facing each other via the coil part 25 and contribute to electromagnetic induction heating, that is, the core 26, the side cores 27, and the center core 28 in the induction heating unit 24, and the inner core 23a in the heating roller 23. By providing the inner core 23a inside the heating roller 23, a good magnetic field can be formed between the core 26 and the inner core 23a, which can heat the heating roller 23 and the fixing belt 22 efficiently.

The pressure roller 30 includes a core metal and an elastic layer including fluorine-containing rubber, silicone rubber, etc., provided on the core metal. The pressure roller 30 presses against the fixing roller 21 via the fixing belt 22.

The sheet P passes through between the fixing belt 22 and the pressure roller 30, which is a fixing nip.

The guide plate 35 is provided upstream of the fixing nip in a sheet transport direction and guides the sheet P to the fixing nip. The separation plate 36 is provided downstream of the fixing nip in a sheet transport direction to guide the sheet P and to help the sheet P leave the fixing belt 22.

The oil application roller 34 contacts a portion of an outer surface of the fixing belt 22 and supplies the fixing belt 22 with oil such as silicone oil to enhance the release property of the fixing belt 22 to toner. The cleaning roller 33 is provided to contact the outer surface of the oil application roller 34 so as to clean the outer surface.

The thermostat 37 is in contact with a part of the outer surface of the heating roller 23. When the thermostat 37 detects that the temperature of the heating roller 23 exceeds a reference temperature, the thermostat 37 cuts electricity to the induction heating unit 24. The temperature detector 38 is provided on the fixing belt 22 to detect a surface temperature of the fixing belt 22 (fixing temperature) directly so as to detect the temperature of the heating roller 23 indirectly and control the fixing temperature. Alternatively, a noncontact temperature detector may be provided as the temperature detector to detect a surface temperature of the fixing belt contactlessly.

Operations of the fixer 20 having the above-described configuration in a fixing process are described below.

With the rotation of the fixing roller 21, the fixing belt 22 rotates in a direction shown by arrow A in FIG. 2 and the cylindrical heating roller 23 rotates counterclockwise. The fixing belt 22 is heated at a position facing the induction heating unit 24 as follows: When a high frequency alternating current (AC) is applied to the coil part 25, lines of magnetic force whose direction switch back and forth are formed between the core 26 and the inner core 23a. The lines of magnetic force induce an eddy-current on the surface of the heating roller 23. Where the eddy-current is induced, Joule heat is generated due to electrical resistance of the heating roller 23. The Joule heat heats the fixing belt 22, which winds around the heating roller 23.

A part of the surface of the fixing belt 22 that is heated by the induction heating unit 24 reaches a contact area with the pressure roller 30 (fixing nip). The sheet P on which the toner image T is formed through the image forming processes is transported in a direction shown by arrow Y10 in FIG. 2 to the fixing nip, guided by the guide plate 35. At the fixing nip, the toner image T is fixed on the sheet P with heat from the fixing belt 22 and pressure from the pressure roller 30, and then the sheet P is discharged from the fixing nip.

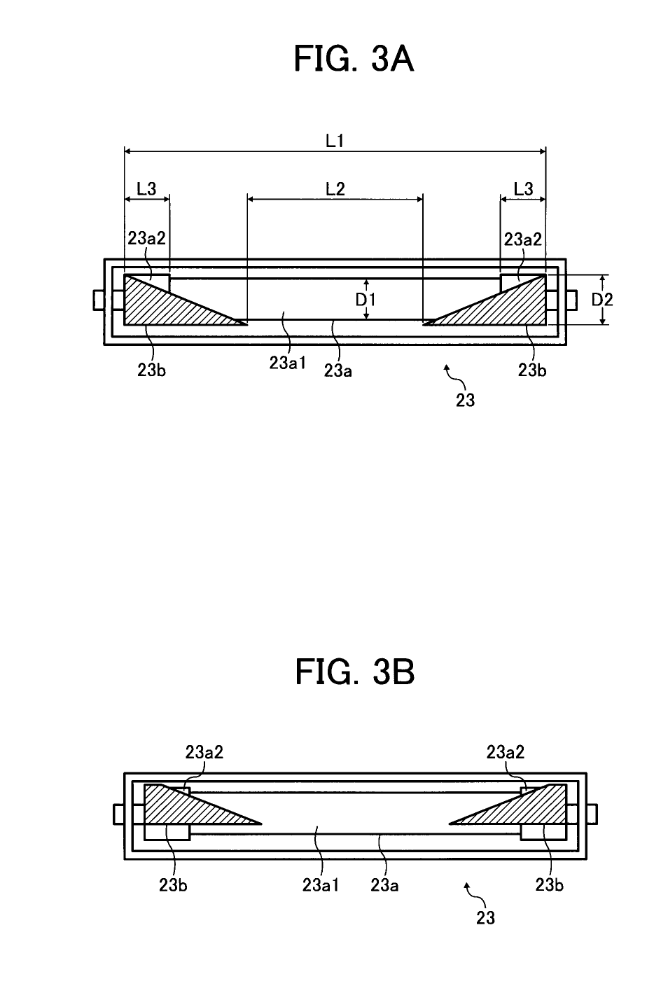

FIG. 3A illustrates the fixing roller 23 viewed from a side of the induction heating unit 24 in FIG. 2. FIG. 3B illustrates a state in which the inner core 23a and the shied 23b are rotated 90 degrees in a circumferential direction (rotation direction) of the inner core 23a from a state shown in FIG. 3A.

Referring to FIG. 3A, the columnar inner core 23a in the fixing roller 23 includes a small diameter part 23a1 in a center portion thereof and large diameter parts 23a2 in both end portions in the width direction. A diameter of the small diameter part 23a1 is indicated by D1, a diameter of the large diameter parts 23a2 is indicated by D2, a full width of the inner core 23a is indicated by L1, a transfer width for a minimum sheet width usable in the image forming apparatus 1 is indicated by L2, and a width of the large diameter parts 23a2 is indicated by L3. The large diameter parts 23a2 are configured to have a diameter (D2) larger than the diameter (D1) of the small diameter part 23a1. It should be noted that the inner core 23a not limited to a solid column, and may be a hollow cylinder.

Each of the shields 23b, which is provided at the end portion of the inner core 23a integrally with the inner core 23a, is configured to decrease (or increase) gradually a shield area of the inner core 23a from the side of an edge surface of the inner core 23a. Because of the above-described configuration, the shield areas of the inner core 23a in the width direction that face the coil part 25 in the induction heating unit 24 can be changed by rotating the inner core 23a and the shields 23b. The inner core 23a and the shields 23b are rotatably driven by a stepping motor, not shown, that is connected to an axis of the inner core 23a. The stepping motor belongs to a separate driving system from a driving system including a driving motor for the fixing roller 21, the fixing belt 22, the heating roller 23, etc., not shown.

As illustrated in FIG. 3B, when the inner core 23a and the shields 23b are rotated 90 decrees, the shield areas of the inner core 23a at the position facing the induction heating unit 24 are largest. In the areas of the inner core 23a shielded by the shields 23b, lines of magnetic force to be formed between the core 26 in the induction heating unit 24 and the inner core 23a are blocked. Therefore, a heating area in the fixing belt 22 is an area excepting portions thereof corresponding to the shield areas, which are poorly heated. In this state, the heating area in the fixing belt 22 has a width equal or close to the width L2 shown in FIG. 3A.

The above-described state is suitable for fixing toner images on sheets having the width L2 continuously. That is, when toner images are fixed on sheets having a minimum usable sheet width, for example, a width of 148 mm, the inner core 23a and the shields 23b are fixed at the positions in the rotation direction thereof shown in FIG. 3B. The fixing process described with reference to FIG. 2 is performed in the above-described state.

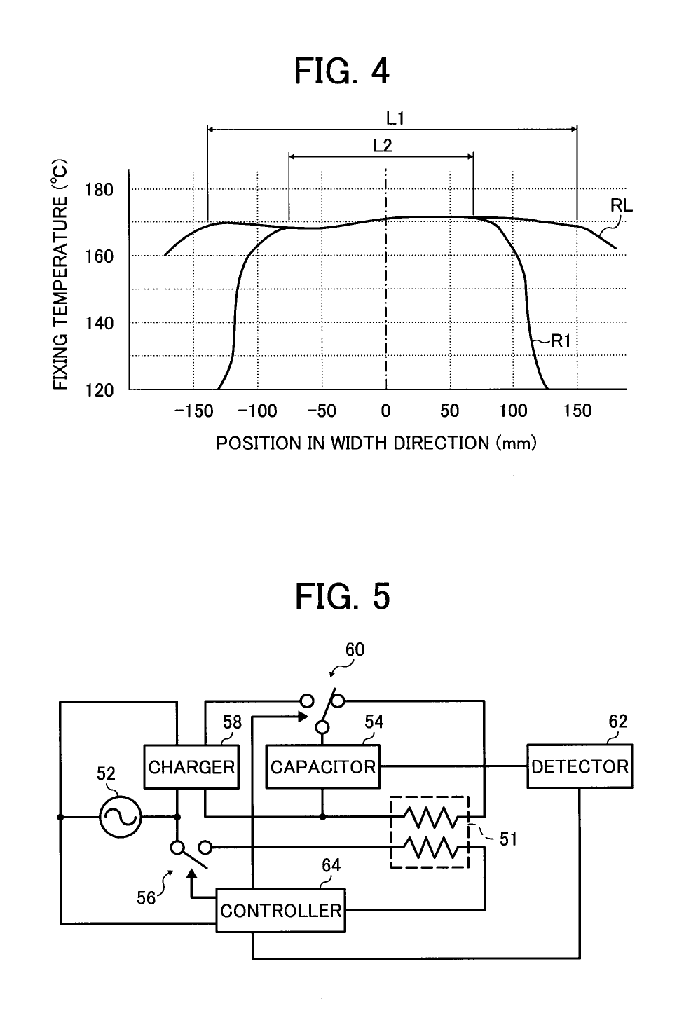

FIG. 4 is a graph illustrating temperature distribution on the fixing belt 22 in the width direction. In FIG. 4, a line RL is the temperature distribution when shields 23b are not used, a line R1 is the temperature distribution when the shields 23b are used, a horizontal axis indicates positions on the heating roller 23 in the width direction from a center thereof in millimeters, and a vertical axis indicates the surface temperature thereof in degrees centigrade.

As shown with the line R1, the temperature distribution on the fixing belt 22 in the width direction is substantially constant in the width L2, and thus the fixing belt 22 provide a good fixing property for sheets having the width L2. Because lines of magnetic force are blocked in other areas of the fixing belt 22 than the width L2, heat is generated only in the area within the width L2. Therefore, heat generation amount per unit width is higher in the case where the shields 23b are used than in the case where the shields 23b are not used, assuming that energy consumption in both cases is equal.

The image forming apparatus further includes an auxiliary power storage unit for the fixer 20. FIG. 5 illustrates an example of a control block of the auxiliary power storage unit. The control block includes a commercial power source 52, a charger 58, a detector 62, and a controller 64. The commercial power source 52 connects to an inner load 51 via the charger 58 and a switch 56. The charger 58 connects to a capacitor 54 as an auxiliary power storage unit via a switch 60.

The detector 62 detects an amount of electricity stored in the capacitor 54 (size of charge) and transmits information about the size of charge to the controller 64. The controller 64 changes the connection of the switch 60 to the inner load 51 to supply power thereto when the size of charge in the capacitor 54 is sufficient and to the charger 58 to charge the capacitor 54 when the size of charge in the capacitor 54 is insufficient, according to the information from the detector 62.

With the above-described configuration, a normal power supply amount can be limited to an allowable amount because electricity in the capacitor 54 can be supplied to the fixer 20 when the fixer 20 requires a large amount of power.

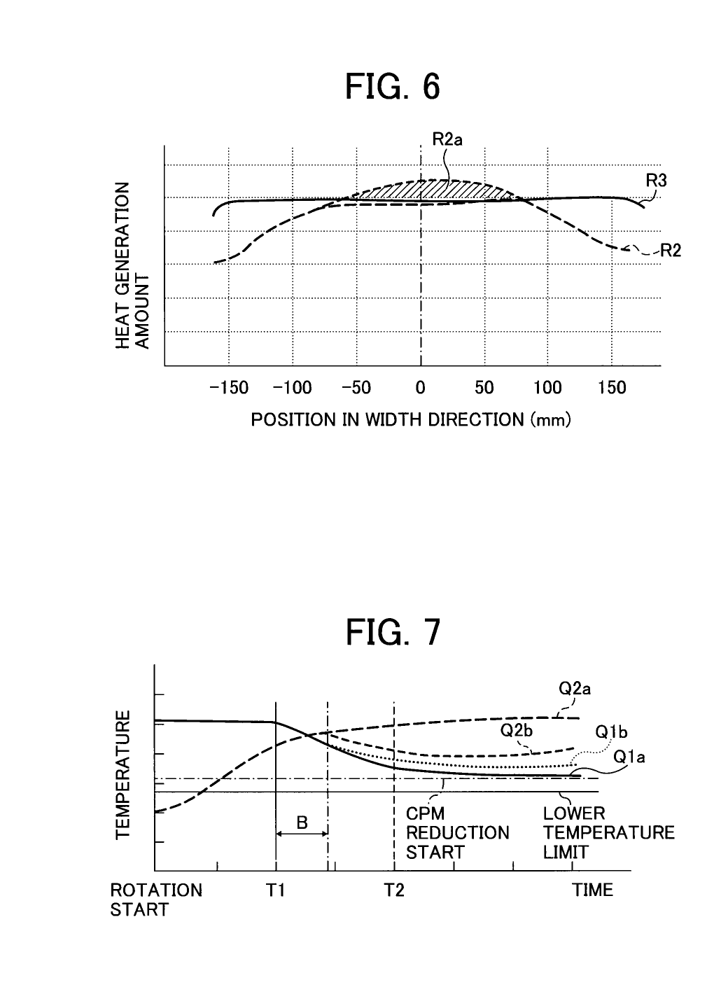

FIG. 6 is a graph illustrating differences in heat generation on the heating roller 23 in the width direction.

In FIG. 6, a line R2 is the distribution of heat generation when sheets are continuously sent to the fixer 20 (temperature stable phase) and a line R3 is the distribution of heat generation at the start of sheet feeding. A horizontal axis shows a position on the heating roller 23 from the center thereof in millimeters and a vertical axis shows the amount of heat generated on the heating roller 23, which may be measured in watts per centimeter. The amount of heat generated in the center portion is increased for an area R2a when the amount of heat generated in the end portions is decreased.

During continuous sheet feeding, sheets take heat from a part of the heating roller 23 corresponding to a width of the sheets and thus the temperature thereof decreases. Therefore, that part of the heating roller 23 is heated to compensate for the heat lost. By contrast, heat is not lost from end portions of the heating roller 23, which are outside of the width of the sheets, and thus temperature of the end portions increases if the end portions are heated as well as the part corresponding to the width of the sheets. Therefore, it is preferable to heat the heating roller 23 only to the extent to compensate for the heat lost. Therefore, it is preferable to heat the heating roller 23 in different ways before the start of sheet feeding and during continuous sheet feeding.

Referring to the line R2, although the part of the heating roller 23 corresponding to the width of the sheets is heated during continuous sheet feeding as well as before sheet feeding is started, the amount of heat generated in the portions outside of the width of the sheets (end portions) is reduced during continuous sheet feeding to prevent end portion temperature rising.

FIG. 7 is a graph illustrating changes in temperature with time in different portions of the heating roller 23. In FIG. 7, a line Q1a shows changes in temperature in a center of the heating roller 23, a line Q2a shows changes in temperature in the end portions of thereof, a horizontal axis shows time passage after the heating roller 23 starts rotating, and a vertical axis shows temperature. A time period from the start of sheet feeding until a predetermined number of sheets are sent to the fixer 20 is shown as a time period B.

As shown by the line Q1a, temperature decreases in the center portion at the start of sheet feeding shown as a reference numeral T1 because sheets take heat therefrom. A reference numeral T2 shows when the amount of generated heat is balanced against heat lost in the center portion and thus temperature therein becomes substantially stable.

By contrast, as shown by the line Q2a, temperature is lower in the end portions at the start of rotation because heat is lost therefrom during a standby mode. However, heat is not lost from the portions outside of a portion where sheets pass through during sheet feeding and thus temperature rises in the end portions if the end portions are continuously heated.

Therefore, it is preferable to reduce the amount of heat generated in the end portions during continuous sheet feeding (temperature stable phase) from the amount of heat generated at the start of sheet feeding as shown by the lines R2 and R3 in the graph of FIG. 6. A line Q2b shows changes in temperature in the end portions of the heating roller 23 when the amount of heat generated therein is reduced during continuous sheet feeding. In the case of electromagnetic induction heating, the amount of heat generated in the center portion increases for the area R2a shown in FIG. 6 when the amount of heat generated in the end portions is reduced.

When the temperature in the center portion decreases to a reference temperature or below, intervals of sheet feeding may be increased, that is, the number of copies per minute is reduced, to reduce amount of heat per unit of time that is lost through the sheets as prevention against a further decrease in temperature. Reduction in the number of copies per minute is hereinafter referred to as CPM reduction. It should be noted that increasing intervals of sheet feeding frequently is not preferable because productivity decreases. The above reference temperature is set as a CPM reduction start temperature to a temperature higher than a lower temperature limit at which fixing properties are maintained.

In the example embodiment described above, the amount of heat generated in the center portion is increased during continuous sheet feeding from the amount of heat generated therein at the start of sheet feeding by reducing heat generation in the end portions during continuous sheet feeding. Therefore, the temperature in the center portion does not easily decrease to the CPM reduction start temperature or below and thus productivity can be maintained.

Therefore, when sheets having a width corresponding to a maximum heating area of the fixing roller 23 are continuously sent to the fixer 20, the advantage that the temperature of the heating roller 23 becomes higher in the end portions than in the center portion thereof after the start of sheet feeding can be used. That is, good fixing properties at the start of sheet feeding as well as stable temperature during continuous sheet feeding can be obtained by reducing the amount of heat generated in the end portions of the heating roller 23 during continuous sheet feeding (temperature stable phase). Therefore, fixing electricity used for a sheet having a width that is most commonly used can be maximized.

The amount of heat generated in the end portions is reduced when a predetermined number of sheets are sent to the fixer 20. The predetermined number of sheets may be fixed. Alternatively, the timing to reduce the amount of heat generated in the end portions may be determined according to fixing conditions as described below.

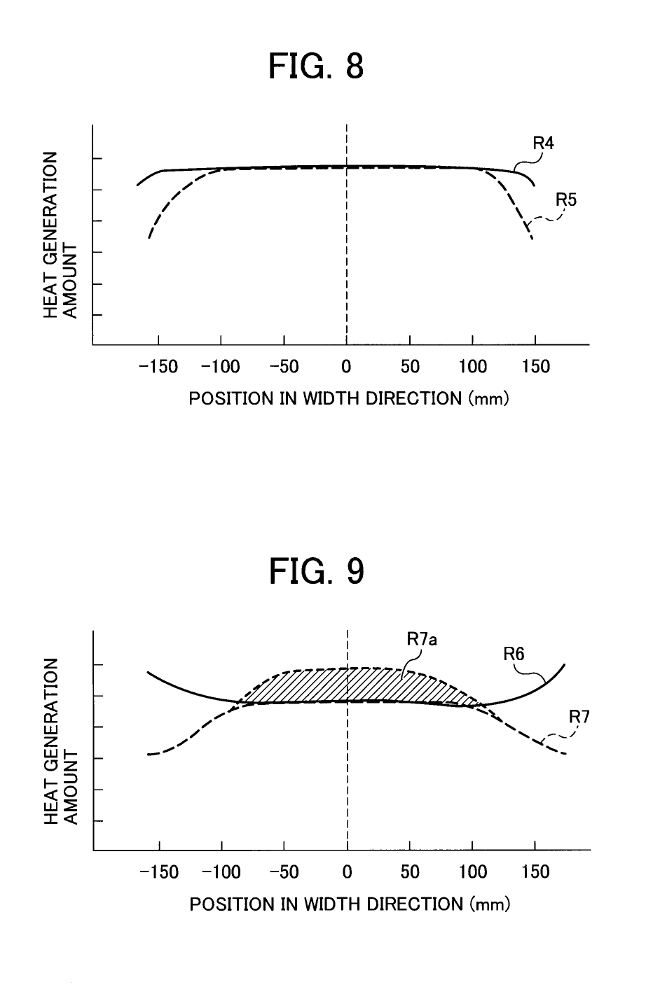

FIG. 8 is a graph illustrating distribution of heat generation when an auxiliary power storage unit is used. A line R4 shows distribution of heat generation when an auxiliary power storage unit is used and a line R5 shows distribution of heat generation when an auxiliary power storage unit is not used.

The fixer 20 can use more power than a normal power supply in the case that the capacitor 54 shown in FIG. 5 releases stored electricity at the start of sheet feeding. Therefore, an overall heat generation amount at the start of sheet feeding can be increased as shown in FIG. 8. Because the fixing belt 22 (fixing member) can maintain a higher temperature at the start of sheet feeding, heat lost therefrom due to contact with other components can be compensated and fixing properties at the start of sheet feeding can be enhanced.

Referring to FIG. 9, a method to raise temperature in the end portions faster at the start of sheet feeding is described below.

In FIG. 9, a line R6 shows distribution of heat generation at the start of sheet feeding, a line R7 is distribution of heat generation during continuous sheet feeding, a horizontal axis shows a position on the heating roller 23 from the center thereof, and a vertical axis shows an amount of heat generated, which may be measured in watts per centimeter. To raise temperature in the end portions faster at the start of sheet feeding, it is preferable to set the amount of heat generated in the end portions higher than in the center portion after the fixer 20 starts rotating. By reducing the amount of heat generated in the end portions during continuous sheet feeding for the increase in the temperature therein at the start of sheet feeding, the amount of heat generated in the center portion can be increased as shown by an area R7a. Therefore, temperature during continuous sheet feeding can be maintained with a lower supply power, and thus productivity can be enhanced.

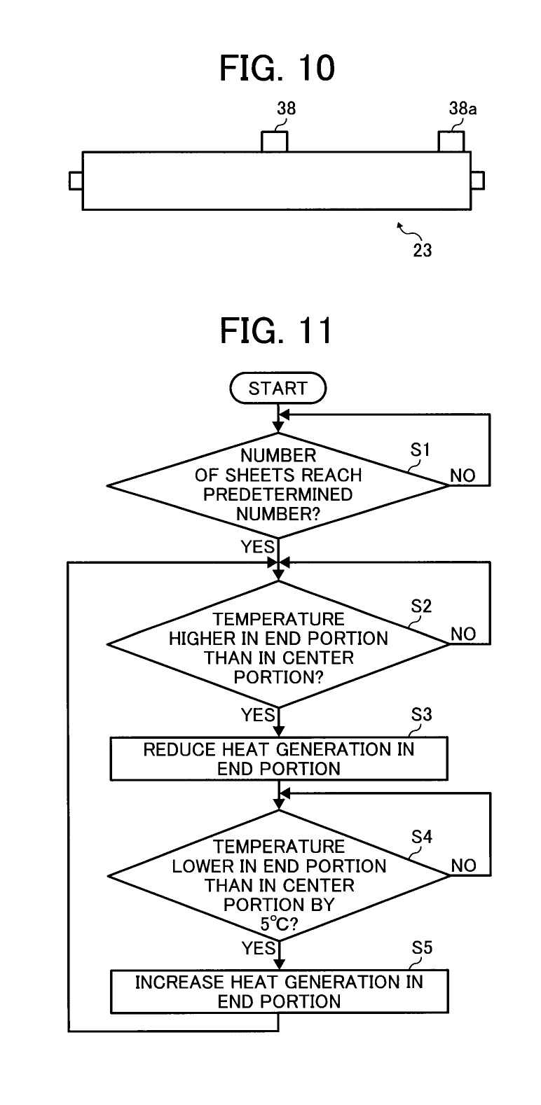

Referring to FIG. 10, a position on the heating roller 23 at which temperature is detected is described. The temperature of the heating roller 23 may be detected indirectly via the fixing belt 22 as described above, although the fixing belt 22 is omitted in FIG. 10.

In FIG. 10, a temperature detector 38a is provided on an end portion of the heating roller 23, in addition to the temperature detector 38 to detect a temperature in the center portion of the heating roller 23 in the width direction. A decrease in heat generation in the center portion during continuous sheet feeding (temperature stable phase) can be detected by monitoring differences in the temperatures detected with the temperature detectors 38 and 38a. Therefore, such a decrease in the amount of heat generated in the center portion can be remedied immediately.

Alternatively, only the temperature detector 38a may be provided on the end portion without providing a temperature detector at the center portion. Reducing the amount of heat generated at the end portions may be started when the temperature in the end portion exceeds a suitable range for fixing or a reference temperature, by monitoring changes in the temperature in the end portion detected by the temperature detector 38a.

When to reduce the amount of heat generated in the end portions can be determined by checking the number of sheets that pass through the fixer 20 and/or a fixing condition, for example, the temperature of the fixing belt 22.

The amount of heat generated in the end portions may be reduced immediately when the temperature in the center portion decreases to a reference temperature or below, or when the temperature in the end portions exceeds a reference temperature. Therefore, the temperature in the center portion can be maintained and fixing properties during continuous sheet feeding can be maintained stable, and thus productivity can be enhanced.

Referring to FIG. 11, steps in a process to control heat generation based on detection of the end temperature are described below.

After a command to start sheet feeding is issued and continuous sheet feeding is started, sheet feeding is continued until the number of sheets sent to the fixer 20 reaches a predetermined number. The controller to control various operations of the image forming apparatus 1 checks whether or not the number of sheets reaches the predetermined number at S1. When the number of sheets reaches the predetermined number (YES at S1), the controller starts to check whether or not the temperature in the end portions is higher than the temperature in the center portion at S2. When the temperature in the end portions is not higher than the center portion (NO at S2), the controller continues sheet feeding. When the temperature in the end portions is higher than the center portion (YES at S2), the controller reduces the amount of heat generated in the end portions at S3. When the temperature in the end portion is lower than the temperature in the center portion by a reference temperature (e.g., 5° C.) or greater (YES at S4), the controller increases amount of heat generated in the end portions to prevent the temperature from falling below the suitable range for fixing at S5 and returns to S2.

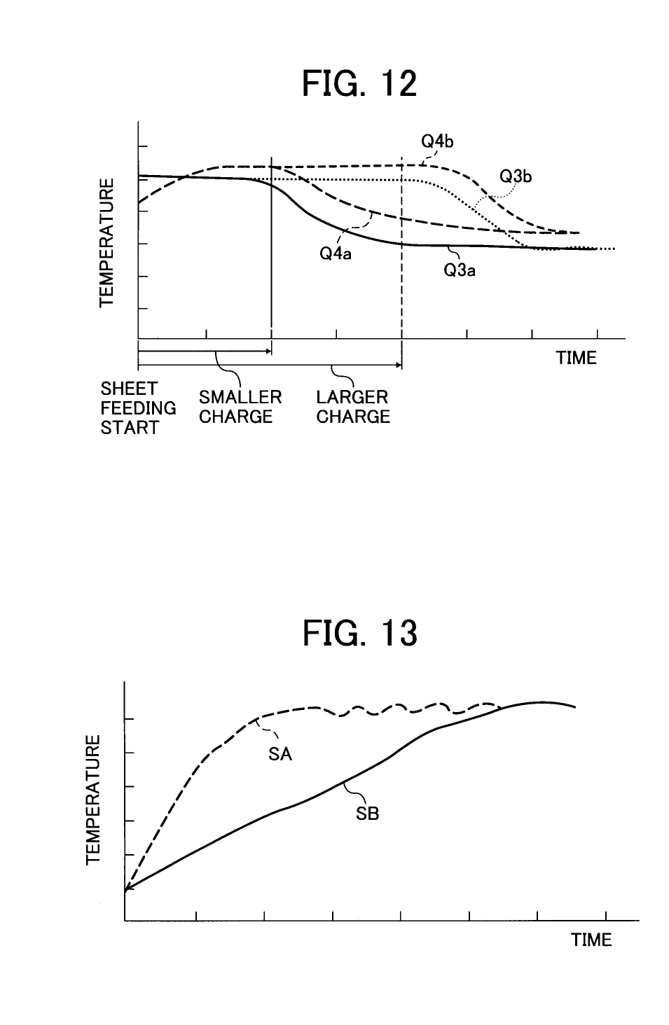

FIG. 12 is a graph illustrating changes in temperature depending on the size of charge after sheet feeding is started. As shown in the graph, temperature on the heating roller 23 changes differently after the start of sheet feeding depending on the size of charge in the capacitor 54 shown in FIG. 5. In the present embodiment, electricity stored in the capacitor 54 is regarded as a fixing condition. In FIG. 12, lines Q3a and Q3b show changes in the temperature in the center portion when the size of charge is smaller and the size of charge is larger, respectively. Lines Q4a and Q4b show changes in the temperature in the end portions when the size of charge is smaller and the size of charge is larger, respectively.

If the size of charge is smaller, temperature decreases faster both in the center portion (Q3a) and the end portions (Q4a) because a decrease in temperature at the start of sheet feeding is not compensated sufficiently. Therefore, the amount of heat generated in the end portion is reduced to increase the amount of heat generated in the center portion before the number of sheets sent to the fixer 20a reaches a normal reference number. By contrast, when the size of charge is larger, the reference number should be set to a larger number because the temperature can be maintained for a longer time period both in the center portion (Q3b) and the end portions (Q4b).

Therefore, the size of charge in the capacitor 54 shown in FIG. 5 is detected with the detector 62. Depending on the detected size of charge, the reference number of sheets, which is a criterion to start heat generation reduction in the end portions, is changed. With the above-described configuration, a decrease in the temperature in the center portion can be reduced and thus good fixing properties at the start of sheet feeding can be maintained with a smaller supply power.

As shown in FIG. 13, temperature change on the heating roller varies depending on fixing method. In FIG. 13, a line SA shows changes in temperature in a fixing roller method and a line SB shows changes in temperature in a fixing belt method.

In the fixing belt method according to the present embodiment, the heating roller 23 includes the core 23a and the shields 23b as shown in FIG. 3A and the heating roller 23 is not directly pressed by the pressing roller 30. Therefore, the heating roller 23 can be thinner and have a smaller heat capacity than that of a heating roller in a fixing roller method in which an induction heating mechanism is included in the fixing roller. Because the heating roller 23 is thinner, the fixing belt 22 can be heated faster, providing high responsiveness.

It should be noted that although the foregoing illustrative embodiment is described using the example of a laser printer as the image forming apparatus 1, the present invention is not limited thereto.

As can be appreciated by those who skilled in the art, numerous additional modifications and variations are possible in light of the above teachings. It is therefore to be understood that, within the scope of the appended claims, the disclosure of this patent specification may be practiced otherwise than as specifically described herein.

What is claimed is:

1. A fixer, comprising:
a fixing member configured to fix a toner image on a recording medium by application of heat;
a coil part configured to extend in a width direction to face the fixing member;
a core part configured to face the coil part and generate heat by electromagnetic induction to heat the fixing member when an electrical current passes through the coil part; and
a shield configured to shield the core part partially to change a heating area of the core part in the width direction,
wherein an amount of heat generated in an end portion of the core part in the width direction is changed when a predetermined number of sheets pass through the fixer during continuous feeding of sheets that are equal in size to a maximum heating area of the fixing member.

2. The fixer of claim 1, wherein the amount of heat generated in the end portion of the core part is larger than an amount of heat generated in a center portion thereof at the start of sheet feeding and is not grater than the amount of heat generated in the center portion thereof after the predetermined number of sheets pass through the fixer.

3. The fixer of claim 1, further comprising:
a temperature detector configured to detect temperature at least in the end portion of the fixing member in the width direction,
wherein the amount of heat generated in the end portion of the core part is changed based on an output from the detector and the predetermined number of sheets.

4. The fixer of claim 1, further comprising:
a temperature detector configured to detect temperature at least in a center portion of the fixing member in the width direction,
wherein the amount of heat generated in the end portion of the core part is changed based on output from the detector and the predetermined number of sheets.

5. The fixer of claim 1, further comprising:
a heating roller configured to face the coil part via the fixing member;
a pressing roller configured to press the recording medium; and
a fixing roller configured to face the pressing roller via the fixing member,
wherein the fixing member is a fixing belt stretched around the heating roller and the fixing roller, the coil part faces an outer circumference of the fixing belt, and the core part and the shield are provided inside the heating roller.

6. An image forming apparatus, comprising:
an image carrier configured to carry a toner image thereon;
a transferer configured to transfer the toner image from the image carrier onto a recording medium; and
the fixer according to claim 1.

7. The image forming apparatus of claim 6, further comprising:
an auxiliary power storage unit configured to store electricity during a standby mode and supply electricity to the fixer when sheet feeding is started.

8. The image forming apparatus of claim 7, wherein the predetermined number of sheets is determined based on a fixing condition including an amount of electricity stored in the auxiliary power storage unit.
